(19) United States
(12) Patent Application Publication
(10) Pub. No.: US 2013/0246684 A1
(43) Pub. Date: Sep. 19, 2013

(54) SYSTEM AND METHOD FOR COMMUNICATING WITH A PLURALITY OF DEVICES

(71) Applicants: Mitchell Dean Cohen, Carson City, NV (US); Robert Ronald Nikkels, Gardnerville, NV (US)

(72) Inventors: Mitchell Dean Cohen, Carson City, NV (US); Robert Ronald Nikkels, Gardnerville, NV (US)

(73) Assignee: GENERAL ELECTRIC COMPANY, SCHENECTADY, NY (US)

(21) Appl. No.: 13/421,401

(22) Filed: Mar. 15, 2012

(51) Int. Cl. G06F 13/00

(52) U.S. Cl. 710/316

(57) ABSTRACT

A system and method that permits a monitoring unit to communicate with any one of several Serial Peripheral Interface (SPI) devices on an input/output (IO) module using a single device select line. The monitoring unit sends a data message with an identifier code to the IO module, which includes a router to selectively activate a corresponding circuit to the selected SPI device based on the identifier code.

### BACKGROUND OF THE INVENTION

The subject matter disclosed herein relates to a system and a method for communicating with a plurality of Serial Peripheral Interface (SPI) devices using an SPI bus which has only a single device select line.

Industrial manufacturing plants employ various types of sensors for monitoring the condition of assets. For example, transducers designed to monitor parameters of an asset (e.g., seismic transducers, proximity transducers, velocity transducers, etc.) can be coupled to the asset and communicate with a monitoring unit. Using information provided by the transducers, the monitoring unit can determine if the asset is experiencing an undesirable condition.

In some installations, the transducers communicate with the monitoring unit via an input/output (IO) module. Certain IO modules include an SPI device, such as a sensor, memory, processor, etc., that communicates with the monitoring unit over an SPI bus to provide, e.g., information about the asset collected by the transducers. Conventional IO modules have a single SPI device allowing monitoring units to communicate with the SPI device of the IO module using an SPI bus with a single device select line. This existing architecture of a single device select line for communications between the monitoring unit and the IO module has limited the IO modules to include only a single SPI device. While newer IO modules can include multiple SPI devices, to use the newer IO modules, it is necessary to upgrade or replace the monitoring unit to provide multiple device select lines. It is desirable to permit a monitoring unit with a single device select line to communicate with multiple SPI devices on an IO module without needing to replace or upgrade the monitoring unit.

The discussion above is merely provided for general background information and is not intended to be used as an aid in determining the scope of the claimed subject matter.

### BRIEF DESCRIPTION OF THE INVENTION

A system and method that permits a monitoring unit to communicate with any one of several Serial Peripheral Interface (SPI) devices on an input/output (IO) module using a single device select line. The monitoring unit sends a data message with an identifier code to the IO module, which includes a router to selectively activate a corresponding circuit to the selected SPI device based on the identifier code.

An advantage that may be realized in the practice of some disclosed embodiments of the IO module is that the IO module can selectively establish a communication link with any one of a plurality of SPI devices on the IO module despite the SPI bus having only a single device select line. This permits backwards compatibility with conventional SPI buses and monitoring units.

In one embodiment, a monitoring system is disclosed. The monitoring unit comprises a plurality of transducers connected to an input/output module, the input/output module comprising a plurality of Serial Peripheral Interface devices, a Serial Peripheral Interface router comprising a data input, a device select input, and a plurality of outputs, a plurality of circuits connecting the plurality of outputs of the Serial Peripheral Interface router to device select inputs of the plurality of Serial Peripheral Interface devices, and a Serial Peripheral Interface bus for routing communications between the monitoring unit and the input/output module, the Serial Peripheral Interface bus comprising a single device select line connected to the device select input of the Serial Peripheral Interface router and a data input line connected to the Serial Peripheral Interface router and the data inputs of the plurality of Serial Peripheral Interface devices, wherein the Serial Peripheral Interface router is configured to read an identifier code in a data message transmitted from the monitoring unit to the input/output module and to activate the device select input of the Serial Peripheral Interface device associated with the identifier code so that the Serial Peripheral Interface device associated with the identifier code can receive the data message.

In another embodiment, a method for communicating between a monitoring unit and an input/output module using a Serial Peripheral Interface bus having a single device select line, wherein the input/output module has a plurality of Serial Peripheral Interface devices, the method comprising the steps of transmitting on the Serial Peripheral Interface bus from the monitoring unit a data message comprising an identifier code identifying a selected Serial Peripheral Interface device from the plurality of Serial Peripheral Interface devices on the input/output module, receiving the data message on the input/output module, reading the identifier code, activating a device select line of the selected Serial Peripheral Interface device based on the identifier code, and receiving the data message on the selected Serial Peripheral Interface device.

In another embodiment, the method comprises the steps of receiving data from a transducer monitoring an asset, transmitting on the Serial Peripheral Interface bus from the monitoring unit a data message comprising an identifier code identifying a selected Serial Peripheral Interface device from the plurality of Serial Peripheral Interface devices on the input/output module, wherein the Selected Peripheral Device has data associated with the transducer, receiving the data message on the input/output module, reading the identifier code, activating a device select line of the selected Serial Peripheral Interface device based on the identifier code, receiving the data message on the selected Serial Peripheral Interface device, and transmitting on the Serial Peripheral Interface bus the data associated with the transducer from the selected Serial Peripheral Interface device to the monitoring unit.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a schematic diagram of an exemplary monitoring system;

FIG. 2 is a schematic diagram of an exemplary IO module with multiple Serial Peripheral Interface (SPI) devices; and

FIG. 3 is a flow diagram of an exemplary method for communicating between a monitoring unit and an IO module using a Serial Peripheral Interface (SPI) bus having a single device select line, wherein the IO module has a plurality of SPI devices.

### DETAILED DESCRIPTION OF THE INVENTION

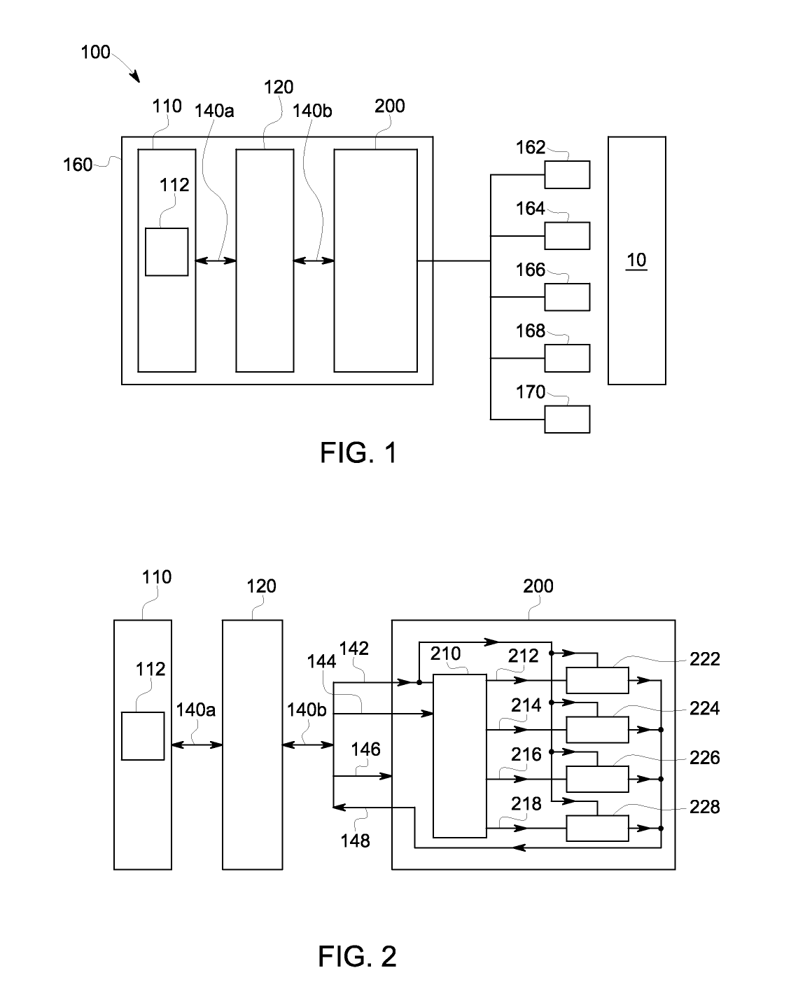

FIG. 1 is a schematic diagram of an exemplary monitoring system 100 for monitoring an asset 10 (e.g., power generating turbines, industrial pumps, processing equipment, etc.). The monitoring system 100 includes a rack 160 that houses a monitoring unit 110 that communicates with an input/output (IO) module 200 through a backplane 120 via a Serial Peripheral Interface (SPI) bus having a first section 140a and a second section 140b (together referred to as bus 140). The IO module 200 communicates with a number of external devices, including transducers 162-168 (e.g., velocity transducers, proximity transducers, seismic transducers, etc.) that are connected to (e.g., wired to or communicate wirelessly with) the IO module.

Proximity transducers can be used to monitor the movement of the asset or a component of the asset by measuring the distance between the transducer and the machine or component. Similarly, seismic transducers can be used to monitor the vibration of a machine by measuring oscillatory motion. Velocity transducers/accelerometers can be used to sense the speed of machine components. In the embodiment depicted in FIG. 1, four transducers are illustrated including first transducer 162, second transducer 164, third transducer 166 and fourth transducer 168. In the embodiment shown in FIG. 1, data received by the IO module 200 from the transducers 162-168 may be relayed to various secondary components, including a recorder 170 that receives output signals via the IO module 200 and stores the monitored parameters for future analysis.

A monitoring unit 110 can provide a user with information regarding the parameters being monitored by the transducers 162-168. The monitoring unit 110 may comprise an illuminated display (e.g., a series of light emitting diodes (LEDs)) and/or may comprise a liquid crystal display or computer screen. The monitoring unit 110 can include a microprocessor 112 for analysis and triggering of alerts when maintenance is deemed necessary.

FIG. 2 is a schematic diagram of an exemplary IO module 200 with multiple Serial Peripheral Interface (SPI) devices 222-228 (first SPI device 222, second SPI device 224, third SPI device 226, and fourth SPI device 228). Examples of SPI devices include logic circuits, volatile and non-volatile memory components, such as EEPROM (Electrically Erasable Programmable Read-Only Memory), analog to digital converters (ADC), latches, etc. It will be understood that the IO module 200 may include as few as two SPI devices, while the maximum number of SPI devices is only limited by practical considerations, such as available space within the IO module 200.

As shown in FIG. 2, the monitoring unit 110 exchanges (transmits/receives) data messages with the IO module 200 through a backplane 120 via the SPI bus 140. In one embodiment, the SPI bus 140 includes a data input line 142 (e.g., MOSI (Master Out Slave In)), a single device select line 144, a clock line 146, and a data output line 148 (e.g., MISO (Master In Slave Out)).

As shown in FIG. 2, the IO module 200 includes an SPI router 210, which is an SPI device, used for routing data messages from the monitoring unit 110 to the particular SPI device 222-228 on the IO module to which the data message was sent by the monitoring unit 110. In one embodiment, the SPI router 210 can comprise a complex programmable logic device (CPLD) or a combination of discrete devices (e.g., shift registers, counters, flip-flops, decoders, etc.) In one embodiment, the monitoring unit 110 transmits a device select line signal to the IO module 200 on the single device select line 144 of the SPI bus 140 to select the SPI router 210. The single device select line 144 is connected to the device select input of the SPI router 210. The device select inputs of the SPI devices 222-228 are connected to the outputs of the SPI router 210 by a plurality of circuits (the first circuit 212 is connected to the first SPI device 222, the second circuit 214 is connected to the second SPI device 224, the third circuit 216 is connected to the third SPI device 226, the fourth circuit 218 is connected to the fourth SPI device 228). It will be understood that, while FIG. 2 shows only a single SPI router 210 on an IO module 200, multiple SPI routers can be used. As will be explained, using just the single device select line 144 along with the data message, the SPI router 210 allows the monitoring unit 110 to communicate with multiple SPI devices 222-228.

The monitoring unit 110 transmits data messages to the IO module 200 on the data input line 142 intended for one of the SPI devices 222-228 on the IO module 200. The data messages sent by the monitoring unit 110 on the data input line 142 are input to the data input of the SPI router 210. The data message includes an identifier code identifying the SPI device 222-228 to which the data message is sent by the monitoring unit. The identifier code is read by the SPI router 210, which, based on the identifier code, activates the device select input of the SPI device 222-228 associated with the identifier code. In one embodiment, the SPI router 210 can activate the device select input of the selected SPI device 222-228 by changing the state of the SPI router 210 output connected to that SPI device 222-228 (e.g., from high to low or from low to high).

The SPI router 210 can parse the data message to extract the identifier code. In one embodiment, the identifier code is in the first byte of the data message. The technical effects is that the monitoring unit 110 can selectively establish a communication link with any one of the plurality of SPI devices 222-228 using the single device select line 144 of the SPI bus 140, the data message identifier code, and the SPI router 210.

For example, in the case of an IO module 200 with four SPI devices (as in FIG. 2) and an SPI router 210 with a decoder, the identifier code in the data message could be 00 (for activating the first SPI device 222), 01 (for activating the second SPI device 224), 02 (for activating the third SPI device 226), or 03 (for activating the fourth SPI device 228). In this embodiment, the identifier code in the data message is input to the SPI router 210, which, like a decoder, selects the output of the SPI router 210 connected to the corresponding SPI device 222-228 based on the identifier code. In another embodiment, the identifier code in the data message is compared to a list of possible identifier codes that correlates each such code to a corresponding SPI device 222-228 connected to a corresponding output of the SPI router 210. As shown in FIG. 2, when the SPI device 222-228 is selected, it can receive the data message from the data input line 142 connected to all of the SPI devices 222-228.

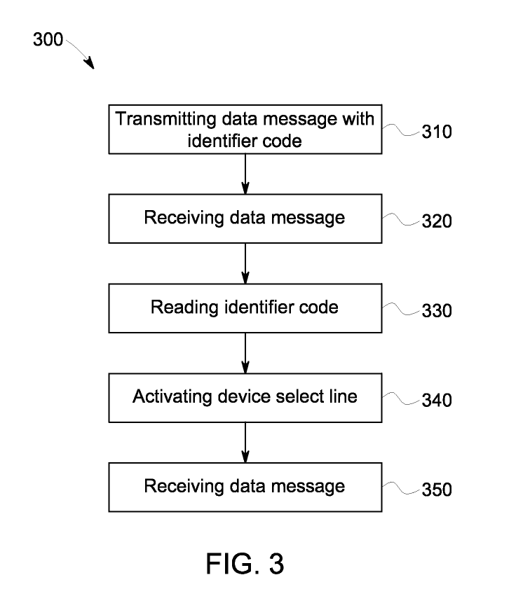

FIG. 3 is a flow diagram of an exemplary method 300 for communicating between a monitoring unit 110 and an IO module 200 using a Serial Peripheral Interface (SPI) bus 140 having a single device select line 144, wherein the IO module 200 has a plurality of SPI devices 222-228. As discussed, at step 310, the monitoring unit 110 transmits on the SPI bus 140 a data message comprising an identifier code identifying a selected SPI device 222-228 from the plurality of SPI devices 222-228 on the IO module 200. In one embodiment, the selected SPI device can have data associated with a transducer monitoring an asset, where the transducer transmits data that is received by the IO module. At step 320, the SPI router 210 receives the data message on the IO module 200. At step 330, the SPI router 210 reads the identifier code, and, at step 340, activates the device select line of the selected SPI device 222-228 based on the identifier code. At step 350, the selected SPI device 222-228 receives the data message. In one embodiment, the selected Serial Peripheral Interface device can transmit the data associated with the transducer on the Serial Peripheral Interface bus data from about the transducer to the monitoring unit.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A monitoring system comprising:
a monitoring unit;
a plurality of transducers connected to an input/output module, the input/output module comprising
a plurality of Serial Peripheral Interface devices,
a Serial Peripheral Interface router comprising a data input, a device select input, and a plurality of outputs;
a plurality of circuits connecting the plurality of outputs of the Serial Peripheral Interface router to device select inputs of the plurality of Serial Peripheral Interface devices; and
a Serial Peripheral Interface bus for routing communications between the monitoring unit and the input/output module, the Serial Peripheral Interface bus comprising a single device select line connected to the device select input of the Serial Peripheral Interface router and a data input line connected to the Serial Peripheral Interface router and the data inputs of the plurality of Serial Peripheral Interface devices,
wherein the Serial Peripheral Interface router is configured to read an identifier code in a data message transmitted from the monitoring unit to the input/output module and to activate the device select input of the Serial Peripheral Interface device associated with the identifier code so that the Serial Peripheral Interface device associated with the identifier code can receive the data message.

2. The monitoring system of claim 1, wherein the plurality of transducers comprises a velocity transducer, a proximity transducer, or a seismic transducer.

3. The monitoring system of claim 1, wherein the plurality of Serial Peripheral Interface devices comprises an Electrically Erasable Programmable Read-Only Memory, an analog to digital converter, or a latch.

4. The monitoring system of claim 1, wherein the Serial Peripheral Interface router is a complex programmable logic device.

5. The monitoring system of claim 1, wherein the Serial Peripheral Interface router comprises a list of codes that correlates the identifier code to a corresponding one of the plurality of Serial Peripheral Interface devices.

6. A method for communicating between a monitoring unit and an input/output module using a Serial Peripheral Interface bus having a single device select line, wherein the input/output module has a plurality of Serial Peripheral Interface devices, the method comprising the steps of:
transmitting on the Serial Peripheral Interface bus from the monitoring unit a data message comprising an identifier code identifying a selected Serial Peripheral Interface device from the plurality of Serial Peripheral Interface devices on the input/output module;
receiving the data message on the input/output module;
reading the identifier code;
activating a device select line of the selected Serial Peripheral Interface device based on the identifier code; and
receiving the data message on the selected Serial Peripheral Interface device.

7. The method of claim 6, wherein the identifier code is in the first byte of the data message.

8. The method of claim 6, wherein the data message is received on the input/output module by a Serial Peripheral Interface router.

9. The method of claim 6, wherein the identifier code is read by a Serial Peripheral Interface router.

10. The method of claim 9, wherein the Serial Peripheral Interface router is a complex programmable logic device.

11. The method of claim 9, wherein the step activating a device select line of the selected Serial Peripheral Interface device based on the identifier code comprises changing the state of an output of the Serial Peripheral Interface router connected to the device select line of the selected Serial Peripheral Interface device.

12. The method of claim 6, wherein the step activating a device select line of the selected Serial Peripheral Interface device based on the identifier code comprises comparing the identifier code to a list of possible identifier codes that correlates the identifier code to the selected Serial Peripheral Interface device.

13. The method of claim 6, further comprising the step of transmitting on the Serial Peripheral Interface bus data from the selected Serial Peripheral Interface device to the monitoring unit.

14. A method for communicating between a monitoring unit and an input/output module using a Serial Peripheral Interface bus having a single device select line, wherein the input/output module has a plurality of Serial Peripheral Interface devices, the method comprising the steps of:
receiving data from a transducer monitoring an asset;
transmitting on the Serial Peripheral Interface bus from the monitoring unit a data message comprising an identifier code identifying a selected Serial Peripheral Interface device from the plurality of Serial Peripheral Interface devices on the input/output module, wherein the Selected Peripheral Device has data associated with the transducer;
receiving the data message on the input/output module;
reading the identifier code;
activating a device select line of the selected Serial Peripheral Interface device based on the identifier code;
receiving the data message on the selected Serial Peripheral Interface device; and
transmitting on the Serial Peripheral Interface bus the data associated with the transducer from the selected Serial Peripheral Interface device to the monitoring unit.

15. The method of claim 14, wherein the identifier code is in the first byte of the data message.

16. The method of claim 14, wherein the data message is received on the input/output module by a Serial Peripheral Interface router.

17. The method of claim 14, wherein the identifier code is read by a Serial Peripheral Interface router.

18. The method of claim 17, wherein the Serial Peripheral Interface router is a complex programmable logic device.

19. The method of claim 17, wherein the step activating a device select line of the selected Serial Peripheral Interface device based on the identifier code comprises changing the state of an output of the Serial Peripheral Interface router connected to the device select line of the selected Serial Peripheral Interface device.

20. The method of claim 14, wherein the step activating a device select line of the selected Serial Peripheral Interface device based on the identifier code comprises comparing the identifier code to a list of possible identifier codes that correlates the identifier code to the selected Serial Peripheral Interface device.
